(19) United States
(12) Patent Application Publication
(10) Pub. No.: US 2024/0241025 A1
(43) Pub. Date: Jul. 18, 2024

(54) IMAGE CAPTURING AND PROCESSING FOR IMMUNOASSAYS

(71) Applicant: Quidel Corporation, San Diego, CA (US)

(72) Inventors: Scott Rongey, San Diego, CA (US); Adonis Stassinopoulos, Del Mar, CA (US)

(21) Appl. No.: 18/412,170

(22) Filed: Jan. 12, 2024

Related U.S. Application Data
(60) Provisional application No. 63/439,036, filed on Jan. 13, 2023.

(51) Int. Cl. G01N 15/06; G06V 10/56; G06V 20/69

(52) U.S. Cl. CPC G01N 15/0612; G06V 10/56; G06V 20/693; G06V 20/695

(57) ABSTRACT

A method for capturing images of a liquid immunoassay to determine a target analyte concentration in a fluid sample includes collecting, with a camera, multiple images of a fluid flow over an assay, the assay including a substrate having a surface that is functionalized with Abs, and the fluid flow including multiple particles, which become bound to functionalized surface when a target analyte is present, combining the images of the fluid flow to obtain a processed image, identifying, in the processed image, one or more particles bound to the substrate, and determining a target analyte concentration in the fluid flow based on a number of particles bound to the substrate. A system including a memory with instructions and a processor to execute the instructions and cause the system to perform the above method is also provided.

### CROSS-REFERENCE TO RELATED APPLICATIONS

This application claims the benefit of U.S. Provisional Application No. 63/439,036, filed Jan. 13, 2023, the content of which is incorporated herein by reference in its entirety.

### TECHNICAL FIELD

The present disclosure is directed to the field of image capturing and processing for quantitative immunoassay assessment. More specifically, the present disclosure is directed to methods for distinguishing bound from unbound particles, in a liquid immunoassay for quantitative assessment of a target analyte in a fluid sample.

### BACKGROUND

Typical immunoassays use antibody or other chemical affinity coated gold nanoparticles or otherwise optically activatable complexes that are fixated to a substrate. Optical excitation or illumination of the substrate enables the quantitative assessment of the immunoassay by simply counting the number of bound nanoparticles or complexes captured with a camera or other optical sensor. However, to ensure that the optical signal is obtained by truly fixated particles or complexes, multiple washes of the assay are typically necessary to remove loosely bound or slowly moving particles that may produce a spurious signal. These washing steps take time, are not necessarily reproducible and controllable, and may even remove some legitimately bound particles or complexes, thus obscuring the measurement.

### BRIEF SUMMARY

In a first embodiment, a method includes collecting, with a camera, multiple images of a fluid flow over an assay, the assay including a substrate having a surface that is functionalized with Abs, and the fluid flow including multiple particles, which become bound to functionalized surface when a target analyte is present, combining the images of the fluid flow to obtain a processed image, identifying, in the processed image, one or more particles bound to the substrate, and determining a target analyte concentration in the fluid flow based on a number of particles bound to the substrate.

In a second embodiment, a system includes a memory storing multiple instructions, and one or more processors configured to execute the instructions and cause the system to perform a process. The process includes to receive an image file including a view of a substrate having an assay and a fluid flow over the substrate, the image file further including one or more particles in the fluid flow bound to the assay, and one or more particles freely flowing over the substrate, to identify multiple attributes of the particles in the image file, to count a number of particles having a selected combination of the attributes, to form a two-dimensional histogram of the particles against the attributes, and to discriminate a free particle from a bound particle based on a location associated to the particle in the two-dimensional histogram from the attributes.

In a third embodiment, a computer-implemented method includes receiving one or more image files including a view of a substrate having an assay and a fluid flow over the substrate, the image files further including one or more particles in the fluid flow bound to the assay, and one or more particles freely flowing over the substrate, identifying multiple attributes of the particles in the image file, counting a number of particles having a selected combination of the attributes, forming a two-dimensional histogram of the particles against the attributes, and discriminating a free particle from a bound particle based on a location associated to the particle in the two-dimensional histogram from the attributes.

In other embodiments, a computer-implemented method includes identifying, from multiple images collected over a period of time, a number of particles bound to an assay exposed to a fluid flow, the fluid flow including multiple free particles configured to become chemically affine to the assay when saturated with a target analyte present in the fluid flow, determining a number of particles bound to the assay over the period of time, and determining a concentration of the target analyte in the fluid flow based on the number of particles bound to the assay.

In certain embodiments of the computer-implemented method, identifying a number of particles bound to the assay comprises averaging the images to form a processed image and applying a threshold mask to remove free particles from the processed image.

In certain embodiments of the computer-implemented method, identifying a number of particles bound to the assay comprises forming a processed image with a geometric average of the images, and applying a threshold mask to remove free particles from the processed image.

In certain embodiments of the computer-implemented method, identifying a number of particles bound to the assay comprises filtering the images with at least one or more colors and combining the images to form a processed image, and applying a color mask to remove free particles from the processed image.

In certain embodiments of the computer-implemented method, identifying a number of particles bound to the assay comprises forming a two-dimensional histogram for particles in the images and identifying the particles bound to the assay based on a location of a point formed with two particle attributes, for each particle, in the two-dimensional histogram.

In certain embodiments of the computer-implemented method, identifying a number of particles bound to the assay comprises selecting multiple image attributes for a particle in the images; forming a multi-dimensional histogram for particles in the images, and identifying the particles bound to the assay based on a location of a point formed with two particle attributes, for each particle, in the multi-dimensional histogram.

In certain embodiments of the computer-implemented method, the fluid flow includes a biological sample from a subject and the target analyte is a biomarker, further comprising assessing a disease condition for the subject based on the concentration of the target analyte.

In certain embodiments of the computer-implemented method, the method further comprises stopping the fluid flow when the concentration of the target analyte in the fluid flow is less than a pre-determined threshold.

In certain embodiments of the computer-implemented method, the method further comprises causing a fluid flow system to wash the assay when a number of free particles in the images is larger than a pre-selected value.

In certain embodiments of the computer-implemented method, the method further comprises adjusting a fluid flow rate based on a precision value for the concentration of the target analyte.

In yet other embodiments, a system includes a first means to store instructions and a second means to execute the instructions and cause the system to perform a method. The method includes identifying, from multiple images collected over a period of time, a number of particles bound to an assay exposed to a fluid flow, the fluid flow including multiple free particles configured to become chemically affine to the assay when saturated with a target analyte present in the fluid flow, determining a number of particles bound to the assay over the period of time, and determining a concentration of the target analyte in the fluid flow based on the number of particles bound to the assay.

These and other embodiments will be clear to one of ordinary skill in the art in view of the following.

### BRIEF DESCRIPTION OF THE FIGURES

FIG. 1 is a schematic illustration of a system configured to capture and process an image of a liquid immunoassay, according to some embodiments.

FIGS. 2A-2C are schematic illustrations of an image capture configuration of a liquid immunoassay including bound and unbound particles, according to some embodiments.

FIGS. 3A-3B illustrate two analysis strategies using time lapse and color discrimination to distinguish bound from unbound particles for immunoassay images captured with the configuration of FIGS. 2A-2C, according to some embodiments.

FIGS. 4A-4D illustrate pictures of a liquid immunoassay collected with the configuration of FIGS. 2A-2C, and the resulting analysis, according to some embodiments.

FIGS. 5A-5B illustrate two-dimensional (2D) histogram analysis to distinguish bound from unbound particles from images of a liquid immunoassay collected with the configuration of FIGS. 2A-2C, according to some embodiments.

FIG. 6 is a flow chart illustrating steps in a method for capturing images of a liquid immunoassay to determine a target analyte concentration in a fluid sample, according to some embodiments.

FIG. 7 is a flow chart illustrating steps in a method for analyzing images from a liquid immunoassay, according to some embodiments.

FIG. 8 is a flowchart illustrating steps in a method for determining a target analyte concentration in a fluid sample, according to some embodiments.

FIG. 9 illustrates a block diagram of a computer system configured to perform at least one or more steps in the methods of FIGS. 6-8, according to some embodiments.

FIG. 10 shows images constructed according to the process described in Example 1.

FIGS. 11A-11E are images before and after color-based pixel filtering, which were constructed according to the process described in Example 2.

FIGS. 12A-12E are images before and after color-based pixel filtering, which were constructed according to the process described in Example 3.

FIG. 13 is a 2D histogram showing the distribution of metrics for particles detected in images captured according to Example 4.

FIGS. 14A and 14B are plots for the main and secondary peaks, respectively, for objects located by the process described in Example 4.

In the figures, elements having the same or similar label are associated with the same or similar attributes, unless explicitly expressed otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments disclosed herein include methods and systems for identification and quantitation of particles bound to a surface in a liquid immunoassay by reducing the interference from free and moving particles. Some exemplary embodiments include immunoassays fixating gold nanoparticles (GNPs). One of ordinary skill will recognize that methods disclosed herein apply more generally to cases where bound objects are being detected in an environment with free objects present.

Optical GNP measurements typically exploit the wavelength dependency of the scattered light from plasmon resonances resulting from the shape, size, and composition of GNPs used for liquid immunoassays to differentiate GNPs from other objects scattering light in the sample fluid. Accordingly, current methods for quantifying GNPs involve color imaging of the substrate with a color CMOS bearing a Bayer pattern and then using an image processing algorithm to detect and classify the particles (classification algorithm); the color image has three color channels: red, green, and blue (RGB) which can be deconvoluted from an RGB image giving R, G and B analyses of the same physical entity. An equivalent process is to take monochromatic images under R, B or G illumination (e.g., single wavelength light emitting diodes—LEDs—) or filtering, and convolute them into an RGB image.

In liquid immunoassays, a goal is to have an accurate count of particles attached to an assay laid on a substrate. To do this, optical techniques offer an efficient and non-invasive avenue. However, the presence of free particles interferes with the accurate determination of the number of fixed particles. Even at low analyte concentration, a small number of free particles (e.g., not cleared away during the wash process) can be significant compared to the number of specifically captured particles (e.g., the particles captured as the immunoassay sandwich). To overcome this problem, many techniques rely on repeated washes of the assay for removing loosely bound or unbound particles from the assay. Some attempts include running a reference assay on a slide that is rigorously washed and then dried to have a reference picture of a purely bound particle measurement. However, these washes and reference measurements take time, are unreliable, do not provide a full removal of unbound particles, and often times end up removing legitimately bound particles.

The above shortcomings result in longer assay analysis, high variability in results, and inaccurate count at best. To resolve the above problem, embodiments as disclosed herein use the fact that the populations of bound and free particles behave differently over time when liquid is present, particularly when the liquid is flowing. Bound particles maintain a fixed location on the substrate, while free particles are free and change location over time (e.g., drifting along the direction of flow, or simply by Brownian motion). Accordingly, some embodiments implement different time collection strategies to either remove unbound particles, or clearly identify them in a properly processed image.

Embodiments as disclosed herein provide methods for discriminating between free and bound particles to achieve accurate and timely assessment of liquid assays. The improved accuracy afforded by methods consistent with the present disclosure is better reflected in low-analyte count configurations, where the ability to reject free particles when counting the number of captured particles has a higher impact in sensitivity and precision.

An added benefit of methods as disclosed herein is the substantially reduced time to obtain an assay result, due to the reduction or elimination of multiple washing steps. Accordingly, an assay determination can be performed reliably after just a few wash steps to reduce the free particle concentration. In some embodiments, a faster assay termination may be determined when the signal falls below a preselected limit, specific for each assay, because false positive counts are highly unlikely. In some embodiments, an assay termination may be accelerated in real time based on the amount of specific capture occurring for the sample being evaluated. For example, a high analyte concentration sample can tolerate more free particles being present when determining the number of captured particles because of the much lower interference of free particles in positive counts.

Furthermore, embodiments as disclosed herein enable system designs that need less reagent volume or fewer components. Indeed, an increased robustness to the presence of free particles relaxes the requirement for wash performance. Thus, lower wash volumes or other components (agitators, sample oscillation, reagents) may be necessary.

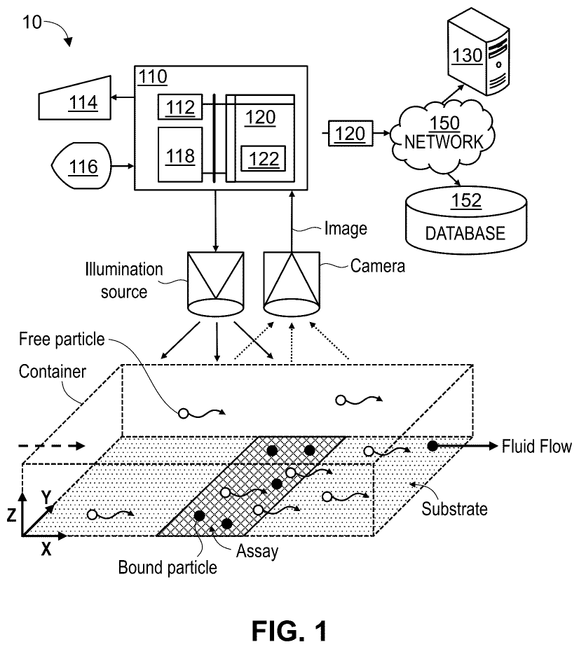

FIG. 1 is a schematic illustration of a system 10 configured to capture and process an image of a liquid immunoassay, according to some embodiments. The system includes a camera directed to a container wherein a fluid flow occurs. The fluid flow includes a sample having an unknown concentration of a target analyte (e.g., a pathogen, a contaminant, a signaling protein, hormone or chemical, a piece of a nucleic acid string—DNA, RNA). In addition, the fluid flow includes particles configured (“functionalized”) to capture the target analyte (e.g., by forming a covalent bond) and, when bound to an analyte molecule (formation of an Ab-analyte complex). An illumination source points towards the fluid sample and provides illumination light that is scattered back forming the image in the camera. Generally, the illumination source may include an LED, a light bulb, a laser, a gas lamp, or any combination thereof. The illumination source may include a white light source (e.g., an LED), which may be filtered sequentially in time for different spectral bands or colors (e.g., RGB). The illumination source may include lasers (e.g., a red, a green and a blue laser), lamp bulbs, gas lamps, or any combination thereof.

The substrate includes an assay portion that is likewise functionalized to attach to the target analyte forming an Ab-analyte complex. Accordingly, an immune complex including a particle-analyte-substrate will be fixed on the substrate (multiple target analyte molecules captured on the surface of the particles will also be captured by the assay on the substrate, thereby binding the particle to the substrate). Depending on the number of particles and the concentration of the target analyte in the fluid flow, some of the particles will become bound to the surface. In any given configuration, it is expected that a large number of particles remain freely moving with the fluid. The free particles move along the flow direction, and they may also move randomly due to Brownian motion. The particles scatter light derived from a focused source and this is captured in images collected by the camera. Bound gold nanoparticles particles have a more intense scattering, due to localized plasmon resonance while the free particles have scattering that is dimmer, the further away from the surface. Free particles in the approximately same distance as the bound from the surface will be captured as such by the system, while others that are further away will contribute general brightness that causes general increased background.

The camera collects pictures across a field of view (FOV) a rectangle in the XY plane capturing a number of bound particles and free particles. The images are transmitted to a client device 110 (which may be part of, or integrally coupled with, the camera) for processing and analysis. The processing and analysis is performed by a processor 112 executing instructions stored in a memory 120, as part of an application 122 hosted by a remote server 130, through a network 150. Client device 110 transmits and receives data 120 from remote server 130 or database 152 via network 150 through a communications module 118. Client device 110 may include an input device 114 (e.g., a mouse, a pointer, a touchscreen display, and the like) and an output device 116 (e.g., a microphone, a screen, and the like).

In some embodiments, the camera has a red-green-blue (RGB) pixel array, e.g., an RGB CMOS featuring a Bayer pattern. In addition, some embodiments include an illumination source such as a white light. In some embodiments, the illumination source may include red, green and blue illumination sources (e.g., lasers or light-emitting diodes) that shed colored light to the sample at selected times. In some embodiments, the camera may be monochromatic, e.g., black and white (B&W), or Grayscale CMOS and include multiple color illumination sources (e.g., RGB). Accordingly, RGB images of the sample flow including free and bound particles are collected by combining the R, G and B components in either the detector, or the illumination source.

In some embodiments, the camera captures RGB information (colored images) simultaneously in the three colors built in the camera. In this configuration, all particles, free or bound, are captured at the same time. In some embodiments, the camera captures single color information (grayscale) with the color defined by the LED in use at a different instance, with different LEDs to collect R, G and B images. This configuration may be better suited for distinguishing bound particles because individual images will be captured at staggered timepoints, and thus free particles will appear colored in each of the different illumination colors, while bound particles will present a distinct color mix. In addition, the colors can be tailored to the spectral properties of the GNPs, including spectral areas outside the visible region other than a RGB CMOS. This configuration also offers a better resolution for each image as the whole CMOS surface is used for each color, instead of different colors sharing the available pixels in the form of an RG, GB combinations (e.g., Bayer pattern, and the like).

In some embodiments, the number of particles mixed in the fluid for a sample run may include millions. Before washing, there is a large excess of free particles in the fluid. After washing, a few thousand, then up to 100,000 particles, may be bound on an assay, while an indeterminate number of free particles may still be above them. In some embodiments, the camera may start taking pictures after a few wash cycles. However, washing will not get rid of all unbound particles. In some embodiments, heat gradients generated by the electronic equipment can cause convection current, which tends to move free particles around. Accordingly, system 10 enables the distinction between bound and free particles in a flowing assay without multiple washes or drying the substrate prior to collecting images.

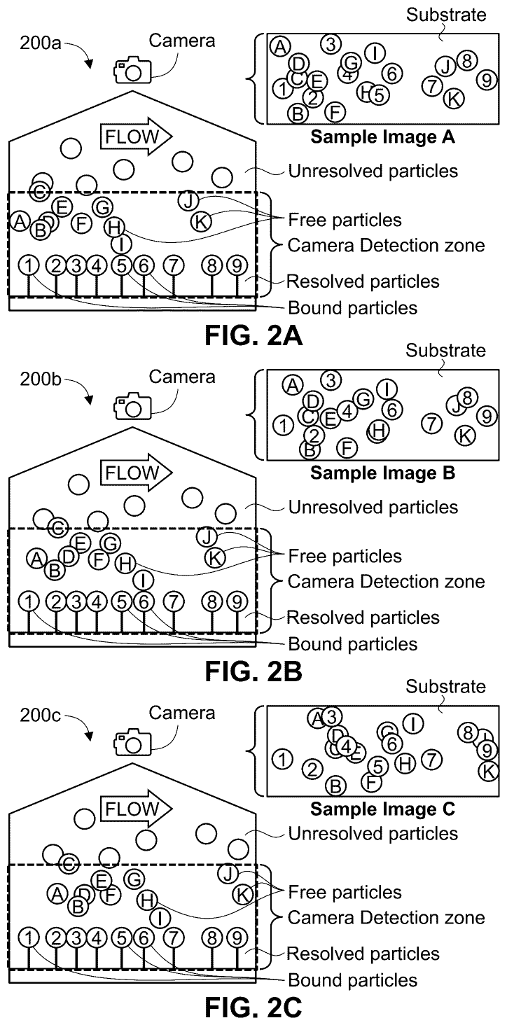

FIGS. 2A-2C are schematic illustrations 200A, 200B, and 200C (hereinafter, collectively referred to as “illustrations 200”) of an image capture configuration of a liquid immunoassay including bound and unbound particles, according to some embodiments. Illustrations 200 include a side view where liquid flows over a surface functionalized with bound antibodies used to capture particles and sample images A, B, and C of the substrate, which are collected by a camera at three distinct timepoints (e.g., separated by about 100 milliseconds, or more). The sample images are 2D images of the surface, including bound and free particles within a camera detection zone (e.g., focal depth). The camera is focused on the surface, and the resolved particles near the surface appear as small, well-focused circles (focal zone); particles outside the focal zone can add to the overall brightness, but the individual particles are not visually resolved. The GNPs in the camera detection zone labeled with numbers represent the bound GNPs. Free GNPs in the camera detection zone are labeled with letters. Free GNPs tend to move with the flow of the liquid covering the surface, and by Brownian motion.

The sample images show that the numbered (e.g., bound) GNPs do not move. By contrast, letter labeled (e.g., free) GNPs have moved to the right in each sequential image (e.g., in the direction of flow). The unresolved GNPs (shown as yellow, un-labelled circles) are not seen in the sample images, but they may produce background illumination that may be removed to enhance counting accuracy, according to some embodiments. In some embodiments, sample images collected at different times are used to construct new images that clearly differentiate between free (lettered) and bound (numbered) GNPs. Note that a single sample image may not be sufficient to distinguish free from bound GNPs. Accordingly, embodiments as disclosed herein combine two or more sequential images (e.g., sample images A, B, and C) to differentiate between free and bound GNPs by leveraging the fact that the free GNPs appear in different locations in each image. On the contrary, bound GNPs remain in the same location.

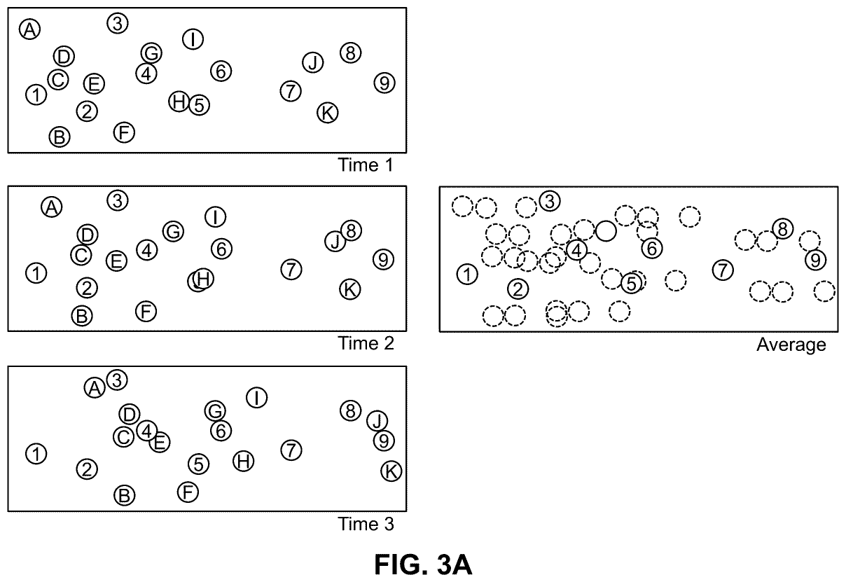

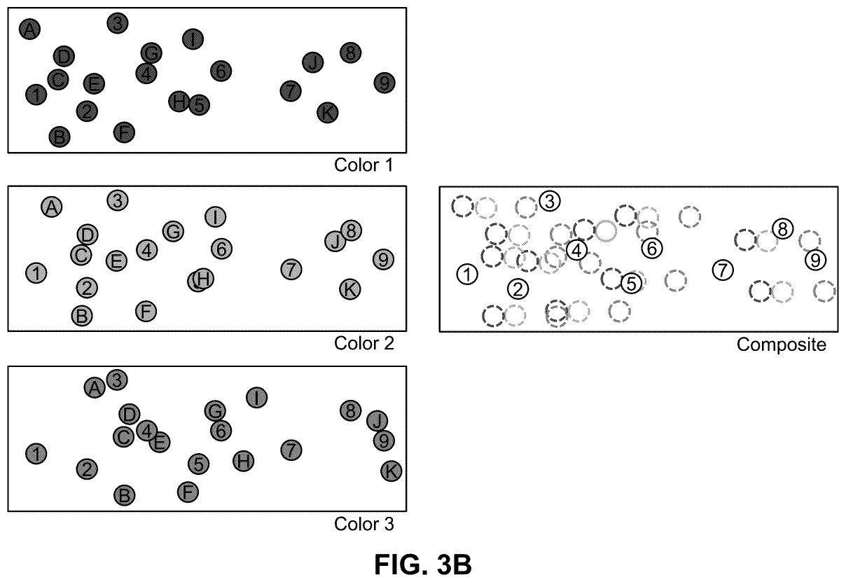

FIGS. 3A-3B illustrate two analysis strategies to distinguish bound from unbound particles for immunoassay images captured with the configuration of FIGS. 2A-2C, according to some embodiments. Even though the analysis strategies herein make it look like there are more particles when there are free particles, they look different such that they can be discriminated, or filtered out, from bound particles. Therefore, the classification process can count bound particles while rejecting free particles.

FIG. 3A illustrates three images collected at different times (Time 1, Time 2, and Time 3). An average image is constructed by averaging the pixel intensities of three sequential images. Each of the bound GNPs will look essentially the same in each image (e.g., same location and intensity), so the average of its location will look essentially the same as an individual image. In contrast, the locations where a free GNP appears is different in each image, so the composite will have more objects (e.g., 3 objects for each free GNP when averaging 3 images), but the pixel intensities for each of these objects will be at least ⅓ of the original in this example lower because at each of these locations the GNP intensity in one image is being averaged with the background intensities in the other images. As a result, the average image reveals only the bound (numbered) GNPs. The locations of the free GNPs are shown as dotted outlines, indicating much weaker images. While this approach creates more objects in the average image, the objects related to the free GNPs have lowered intensities and therefore will be easier to differentiate (and remove, if desired, e.g., by applying an intensity threshold mask) from the bound GNPs.

FIG. 3B illustrates how a composite image using red (Time 1), green (Time 2), and blue (Time 3) color channels for the composition, where the images are the same images collected at three different times in FIG. 3A. Each of the bound (numbered) GNPs will look essentially the same in each image (e.g., same location, intensity, and RGB colors), so the composite image will look essentially the same as an individual image. The composite image will have more objects due to the free GNPs being in different locations in each image. However, the additional objects look less like a GNP due to how the color channels are combined. For these particles, at each location of a free particle, one channel (e.g., Red) has the correct GNP intensity while the other two channels (e.g., Green and Blue) will have the background intensity. Therefore, when stacking the red, green, and blue channels together to make the RGB image, each location of a free GNP will be comprised on one channel with GNP intensity and the other two channels will have background intensity. This combination lowers the overall intensity of the object at the location (similar to the averaging approach in FIG. 3A), but it also changes the perceived color of the object. For example, for the three objects corresponding to one of the free particles, one object will be more red (and less green and blue), another object will be more green (and less red and blue), and one object will be more blue (and less red and green). Thus, even though the composite image includes more objects, the objects corresponding to the free GNPs are easier to differentiate from the bound GNPs because they will be different in both intensity and spectral content. As a result, the composite image shows bound (numbered) GNPs as orange circles (e.g., the superposition of red+green+blue spectra). The locations of the free GNPs are shown as dotted outlines that, in addition to having weaker intensity, have a distinct color that is red, blue, or green, and not orange.

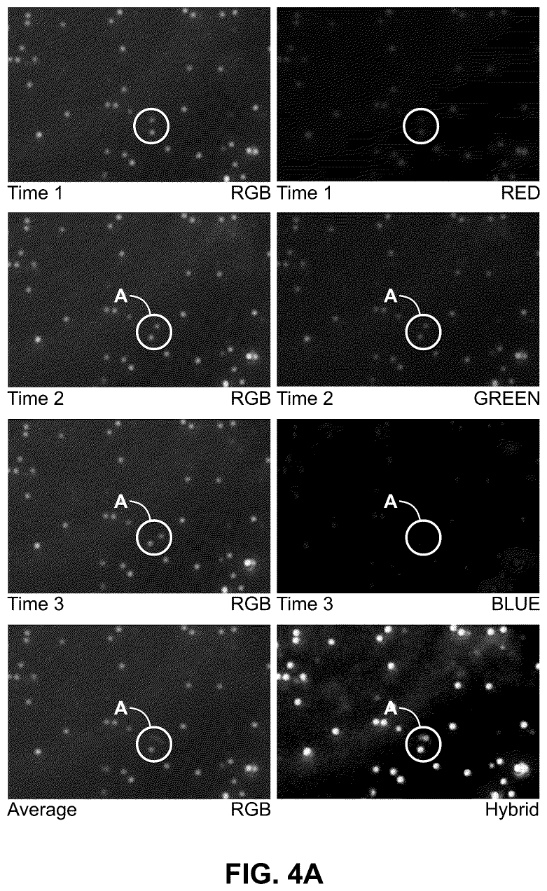

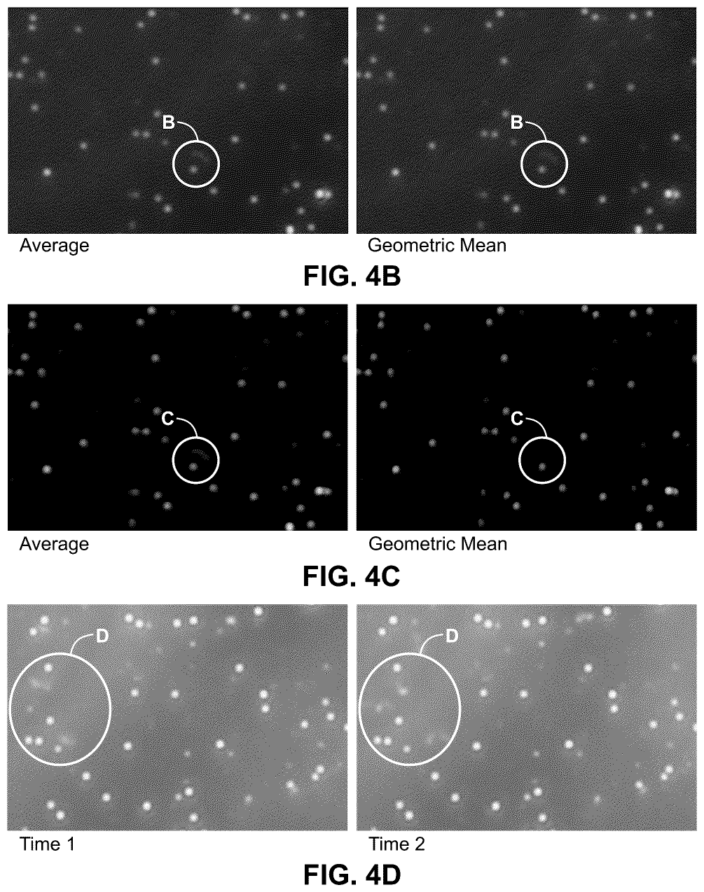

FIGS. 4A-4D illustrate partial portions of actual GNP images of a liquid immunoassay collected with the configuration of FIGS. 2A-2C, and the resulting analysis, according to some embodiments. The immunoassay includes antibodies against IL6 which are either immobilized on the sensor surface, or bound on the GNPs. When IL6 is present, an immune complex is generated, resulting in the attachment of a GNP on the substrate through the immune complex. At the same time, the excess of GNPs which are free, appear in the pictures as less intense GNPs with variable locations. The images are manipulated at the level of individual pixel intensities for each color channel. Without loss of generality, a typical RGB image uses 8-bit integers for each color channel. This 8-bit format allows for intensity values that are whole numbers providing a dynamic the range of 0 to 255. Other configurations may have different dynamic ranges afforded by a greater or smaller bit encoding, depending of the application. Note, sometimes these values are normalized to a 0 to 1 range.

FIG. 4A illustrates three consecutive actual images (Time 1, Time 2, and Time 3) used to create an average image, and a hybrid image (Red+Green+Blue). A selected area A illustrates a bound GNP both in the average image (bright spot) and the hybrid image (yellow spot). In the average image, selected area A shows free GNPs as blurred spots, while the hybrid image clearly shows the different positions of the Red, Green, and Blue spots moving across the field of view. In summary, a bound particle looks essentially the same in the new image as it did in the individual images. And a free particle appears as multiple particles (e.g., three particles can be seen when using three images). Moreover, free particles look different in the new image, compared to the original images. When averaging images, each of the three particles seen for a free particle has a lower brightness (e.g., ⅓ of the original), as expected. When combining color channels from different images, each of the three particles has a different color profile, as well as a lower brightness.

More specifically, the average and hybrid images in FIG. 4A are obtained as follows: Ri indicates the pixel intensity for a given pixel of the red channel of the i-th image, Gi indicates the pixel intensity for a given pixel of the green channel of the i-th image, and Bi indicates the pixel intensity for a given pixel of the blue channel of the i-th image. Then:

Averaging images are obtained with (RGB)ave channels:

$$R ave = ( R 1 + R 2 + R3 ) / 3 \qquad ( 1.1 )$$

$$G ave = ( G 1 + G 2 + G 3 ) / 3 \qquad ( 1.2 )$$

$$B ave = ( B 1 + B 2 + B 3 ) / 3 \qquad ( 1.3 )$$

Eqs. 1.1, 1.2, and 1.3 (hereinafter, collectively referred to as “Eqs. 1”) are carried through independently for each pixel location in the image. The pixels are averaged independently for each color channel, and the average values are used for the final, averaged RGB image.

For the hybrid RGB image, a different color channel from each of the above three images (Time 1, Time 2, and Time 3), the three locations where free GNP appear are as follows: Location 1 (Time 1): where the free GNP appears in the 1st image, Location 2 (Time 2): where the free GNP appears in the 2nd image, and Location 3 (Time 3): where the free GNP appears in the 3rd image.

The delay between taking the sequential images (Time 1, Time 2, and Time 3) may be selected to allow free GNPs to move away from the previous location such that all three locations are non-overlapping regions in the images. The hybrid RGB image is constructed by stacking the Red Channel from the 1st image, the Green Channel from the 2nd image, and the Blue Channel from the 3rd image. In other words:

$$RHyb = R 1 , GHyb = G 2 , Bhyb = B 3$$

FIG. 4B illustrates the average image of FIG. 4A, obtained according to Eqs. 1, and a geometric mean image. Selected area B includes the same particles as selected area A. To obtain the geometric mean image from the three images in FIG. 4A (Time 1, Time 2, and Time 3), a geometric mean calculates the root of the product of a series of values:

$${R}_{g e o} = \sqrt[3]{{R}_{1} \cdot {R}_{2} \cdot {R}_{3}} \qquad ( 2.1 )$$

$${G}_{g e o} = \sqrt[3]{{G}_{1} \cdot {G}_{2} \cdot {G}_{3}} \qquad ( 2.2 )$$

$${B}_{g e o} = \sqrt[3]{{B}_{1} \cdot {B}_{2} \cdot {B}_{3}} \qquad ( 2.3 )$$

Eqs. 2.1, 2.2, and 2.3 (hereinafter, collectively referred to as “Eqs. 2”) are performed for each pixel and color channel using the three images. In this approach, the relative weighting of the individual values reinforces cases where the intensity is high in all images (e.g., a bound GNP) and increases the penalty (e.g., drive result lower) for cases where the intensity is sometimes low (e.g., frec particles that have moved so only the background intensity is seen in some images). Accordingly, the contrast between bound/free particles is expected to be sharper.

FIG. 4C illustrates an average image and a geometric mean image obtained with Eqs. 1 and 2, except after a background subtraction filter reduces the background intensity from the original images in FIG. 4A. A background filter can be applied to subtract the local background intensity for each pixel. By removing the background intensity, the average and geometric mean calculations enhance the distinction between the free GNP and bound GNP intensities by driving the calculated intensity closer to the lower background value. Accordingly, the limitation from the background intensity is reduced so the intensity of the free particles is reduced further. This improvement is noticeably better with the geometric mean: the free GNP is no longer visible at any of the three locations (cf. selected areas C, which correspond to selected areas A and B).

FIG. 4D illustrates yet another embodiment of a time-lapse collection scheme to enhance the distinction between free and bound particles. Accordingly, the camera exposure time (e.g., shutter lapse) has been increased to 1600 milliseconds (ms, compared to 100 ms in FIG. 4A) at two different times (Time 1 and Time 2). Using a longer exposure time is an alternative to averaging a series of images. A longer exposure for an image provides a time-averaging effect to smear out the pixel intensities over a larger area for the free GNPs while maintaining the same pixel area for bound GNPs.

Selected area D includes five objects that stay bright and circular (bound GNPs) and a few other objects that look smeared out over a larger area and have lower pixel intensities (free GNPs). One aspect to consider with this approach is that the background of the images is also increased and this requires the use of less incident light to be effective

Tables I and II below show illustrative examples of calculations performed on the particles (free or bound) in selected areas A, B, C, and D (hereinafter, collectively referred to as “selected areas”), as follows. The following attributes of the particles in the images can be derived, wherein R, G, B represent the pixel intensities for the three colors:

$$Brightness = ( R + G + B ) / ( 255 + 255 + 2 \; 55 ) \qquad ( 3.1 )$$

$$Redness = R / ( R + G + B ) \qquad ( 3.2 )$$

$$Greenness = G / ( R + G + B ) \qquad ( 3.3 )$$

$$Blueness = B / ( R + G + B ) \qquad ( 3.4 )$$

In the tables, a color coding of pixel intensities by location is shown, wherein tan cells indicate the pixel intensities when a GNP is present at the location, and gray cells indicate the background pixel intensities (e.g., when there isn't a GNP at the location). The tables show calculations for a free and a stationary GNP in the selected areas. Free GNPs will be seen in three locations (e.g., a different location in each image—all within the selected areas-). The bound GNPs will be seen at the same location in each image.

TABLE I

| | | | Mobile GNP | | | Stationary GNP |
|---|---|---|---|---|---|---|
| | | | Location 1 | Location 2 | Location 3 | Location 4 |
| Original | Image 1 | R | 40 | 10 | 10 | 40 |
| Images | | G | 60 | 15 | 15 | 60 |
| | | B | 20 | 5 | 5 | 20 |
| | | Brightness | 0.157 | 0.039 | 0.039 | 0.157 |
| | | Redness | 0.333 | 0.333 | 0.333 | 0.333 |
| | | Greenness | 0.500 | 0.500 | 0.500 | 0.500 |
| | | Blueness | 0.167 | 0.167 | 0.167 | 0.167 |
| | Image 2 | R | 10 | 40 | 10 | 40 |
| | | G | 15 | 60 | 15 | 60 |
| | | B | 5 | 20 | 5 | 20 |
| | | Brightness | 0.039 | 0.157 | 0.039 | 0.157 |
| | | Redness | 0.333 | 0.333 | 0.333 | 0.333 |
| | | Greenness | 0.500 | 0.500 | 0.500 | 0.500 |
| | | Blueness | 0.167 | 0.167 | 0.167 | 0.167 |
| | Image 3 | R | 10 | 10 | 40 | 40 |
| | | G | 15 | 15 | 60 | 60 |
| | | B | 5 | 5 | 20 | 20 |
| | | Brightness | 0.039 | 0.039 | 0.157 | 0.157 |
| | | Redness | 0.333 | 0.333 | 0.333 | 0.333 |
| | | Greenness | 0.500 | 0.500 | 0.500 | 0.500 |
| | | Blueness | 0.167 | 0.167 | 0.167 | 0.167 |

Table I shows pixel intensities at each location for each of the three sequential images (in a hypothetical version of what is described herein, similar to e.g., FIG. 4A). Locations 1, 2, and 3 refer to where a free GNP is seen in the three images and Table I indicates the location is bright for the image with the free GNP at that location. A location has the lower background intensity (e.g., 10 for Red, 15 for Green, and 5 for Blue) in the other images in the sequence.

Location 4 is the location for the bound GNP (e.g., the same location for all three images).

For each image, there are two locations within the selected areas with bright pixels (e.g., from the free and bound GNPs) and two locations with the lower background pixel intensities (e.g., images where the mobile GNP has moved away from the location). When looking at a single image, free and bound GNPs are indistinguishable because both types of GNPs may have the same pixel intensities. In some embodiments, a difference in brightness between free and bound GNPs may occur, which only helps in distinguishing the two types.

Table II includes calculations to generate a processed image from the three images collected for Table I (cf. FIG. 4A), as follows.

Average: The pixel intensities are averaged across the three images. This is done independently for each color channel using:

$$I ave = ( I 1 + I 2 + I 3 ) / 3 \qquad ( 4.1 )$$

Where I1, I2, and I3 are the pixel intensities for a given color channel for the three individual images. The brightness is not changed for the bound GNP and reduced, by half in this example, for each location of the free GNPs. The color is not changed for the bound GNP nor for the free GNP.

Hybrid: RGB constructed using: a Red filter from Image 1, a Green filter from Image 2, and a Blue filter from Image 3. The brightness is not changed for the bound GNP and reduced, by different amounts, for each location of the free GNP. The color is not changed for the stationary GNP and is changed, by different amounts for each color, for the free GNPs.

Geometric Mean: The geometric mean is calculated across the three images. This is done independently for each color channel:

$${I}_{g e o} = \sqrt[3]{{I}_{1} \cdot {I}_{2} \cdot {I}_{3}} . \qquad ( 4.2 )$$

Wherein I1, I2, and I3 are the pixel intensities for a given color channel for the three individual images. The brightness is not changed for the bound GNP and reduced for each location of the free GNP, and to a lower value than produced by averaging. The color is not changed for the bound GNP nor for the free GNP.

TABLE II

| | | | Mobile GNP | | | Stationary GNP |
|---|---|---|---|---|---|---|
| | | | Location 1 | Location 2 | Location 3 | Location 4 |
| Constructed | Average | R_ave | 20 | 20 | 20 | 40 |
| Images | | G_ave | 30 | 30 | 30 | 60 |
| | | B_ave | 10 | 10 | 10 | 20 |
| | | Brightness | 0.078 | 0.078 | 0.078 | 0.157 |
| | | Redness | 0.333 | 0.333 | 0.333 | 0.333 |
| | | Greenness | 0.500 | 0.500 | 0.500 | 0.500 |
| | | Blueness | 0.167 | 0.167 | 0.167 | 0.167 |
| | Hybrid | R1 | 40 | 10 | 10 | 40 |
| | | G2 | 15 | 60 | 15 | 60 |
| | | B3 | 5 | 5 | 20 | 20 |
| | | Brightness | 0.078 | 0.098 | 0.059 | 0.157 |
| | | Redness | 0.667 | 0.133 | 0.222 | 0.333 |
| | | Greenness | 0.250 | 0.800 | 0.333 | 0.500 |
| | | Blueness | 0.083 | 0.067 | 0.444 | 0.167 |
| | Geometric | R_geo | 16 | 16 | 16 | 40 |
| | Mean | G_geo | 24 | 24 | 24 | 60 |
| | | B_geo | 8 | 8 | 8 | 20 |
| | | Brightness | 0.062 | 0.062 | 0.062 | 0.157 |
| | | Redness | 0.333 | 0.333 | 0.333 | 0.333 |
| | | Greenness | 0.500 | 0.500 | 0.500 | 0.500 |
| | | Blueness | 0.167 | 0.167 | 0.167 | 0.167 |

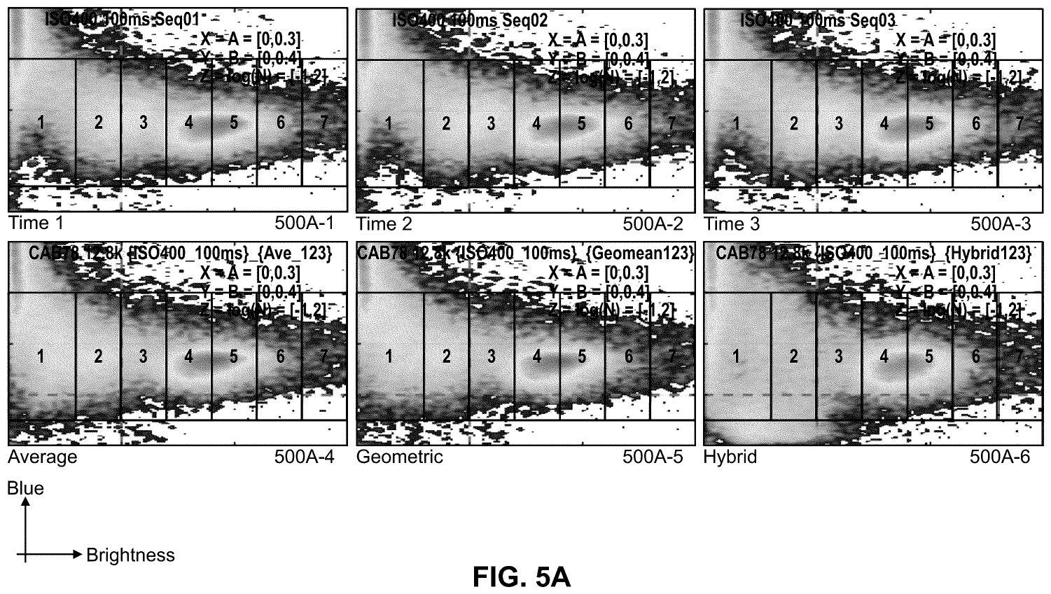

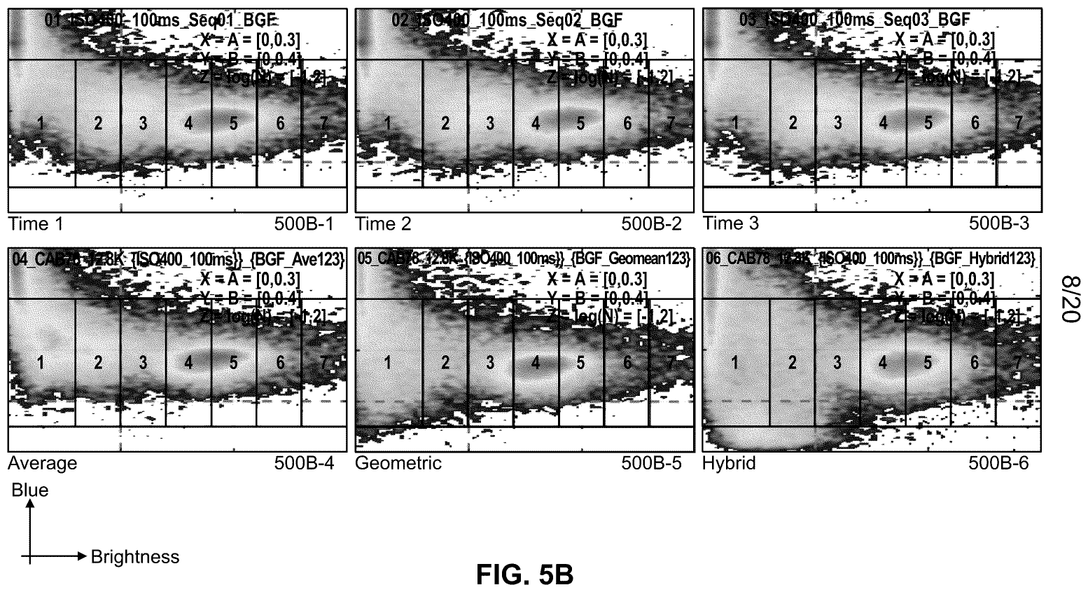

FIGS. 5A-5B illustrate two-dimensional (2D) histogram analysis of GNPs to distinguish bound from unbound particles from images of a liquid immunoassay collected with the configuration of FIGS. 2A-2C, according to some embodiments. The 2D histogram is based on a visual assessment of the distributions for the brightness (abscissae) and “blueness” (e.g., blue pixel value, ordinates) of the objects identified in images such as shown in FIG. 4A. Each 2D histogram may be split into seven (7) brightness regions, as labeled. Brightness regions correspond to different ranges of object brightness for a pre-selected range of blueness values. The colors used in the histogram represent the count density for the various brightness and blueness combinations. Red zones are the highest density and dark blue zones are the lowest density.

FIG. 5A illustrates six plots 500A-1 (Time 1), 500A-2 (Time 2), 500A-3 (Time 3), 500A-4 (Average), 500A-5 (Geometric Mean), and 500A-6 (RGB Hybrid, hereinafter, collectively referred to as “histograms 500A”). 2D histograms 500A may be generated from the analyses of the original three sequential images (cf. FIG. 4A), and from three constructed images (Average, Geometric Mean, Hybrid RGB). Histograms 500A-1, 500A-2, and 500A-3 look very similar to each other: the red spot spanning zones 4 and 5 is due to bound GNPs. The yellow spot spanning zones 2 and 3 is due to free GNPs. And the long red spot along the left edge is due to non-GNP objects (these are very low brightness and not of interest).

In some embodiments, free GNPs are not as bright as the bound GNPs. This is not necessary for discriminating between free and bound particles. In some embodiments, a different combination of parameters may be selected to provide a higher discrimination potential between free and bound particles.

2D histograms 500A-4, 500A-5 and 500A-6 are for images constructed using the average, geometric mean, or hybrid of color channels, respectively (cf. FIGS. 4A, 4B, and 4C). Each histogram 500A-4, 500A-5, and 500A-6 shows the distribution of the metrics for the objects identified by the algorithm that have sizes consistent with GNPs. For 2D histogram 500A-4, the red spot in zones 4 and 5 due to the GNPs looks the same as it does in the individual images, as expected for bound GNPs. The yellow spot that was in zones 2 and 3 (500A-1) has shifted left and is now in zones 1 and 2. This shift to the left indicates a lower brightness, as expected with averaging of images with free GNPs. To note in 2D histogram 500A-4, the blueness (location along the Y-axis) is essentially unchanged, as expected.

2D histogram 500A-5 shows a red spot in zones 4 and 5 remains in that region, as expected for bound GNPs. The yellow spot that was in zones 2 and 3 shifts to the left, indicating a lowering of the brightness similar to what was seen for the simple averaging approach (2D histogram 500A-4). The spot doesn't look quite as yellow as in 2D histogram 500A-4, indicating a lower count density along with the lower brightness. This is consistent with what would be expected for free GNPs.

2D histogram 500A-6 is a hybrid RGB constructed from 3 images (cf. FIG. 4A). The red spot in zones 4 and 5 remains in that region, as expected for bound GNPs. The yellow spot that was in zones 2 and 3 has also been moved away, but in a different manner than it was in either type of averaging approach (cf. 2D histograms 500A-4 and 500A-5). The counts look more spread out. Note how the cyan regions extend over a larger range of blueness values in the region near zones 1 and 2. There is some yellow density near the bottom of zone 1. 2D histogram 500A-6 changes both the brightness and color of the objects originally in zones 2 and 3, as expected for frec GNPs.

FIG. 5B illustrates 2D histograms 500B-1 (Time 1), 500B-2 (Time 2), 500B-3 (Time 3), 500B-4 (Average), 500B-5 (Geometric Mean), and 500B-6 (RGB Hybrid, hereinafter, collectively referred to as “histograms 500B”). 2D histograms 500B are similar to 2D histograms 500A, except for a background subtraction filter used before constructing the new images. The background intensity of the original images the extent to which these image construction techniques can improve the discrimination between free and bound objects.

2D histograms 500B-1, 500B-2, and 500B-3 are collected for the sequential images after the application of a background subtraction filter and the constructs made from these filtered images. And 2D histograms 500B-4, 500B-5, and 500B-6 are for images constructed using the average, geometric mean, or hybrid of color channels (built from background-filtered sequential images), respectively.

2D histograms 500B have similar features and attributes to those discussed in relation to the corresponding 2D histograms 500A. This is expected since the original analysis process applied the background filter during the analysis. Accordingly: the red spot in zones 4 and 5 is due to the bound GNPs; the yellow spot in zones 2 and 3 is due to the free GNPs.

For 2D histogram 500B-4, the yellow spot shifted to lower brightness. The spread along the ordinate axis looks a bit smaller and the yellow spot stays more intense. This indicates that the background subtraction is keeping the distribution tighter. Notably, 2D histogram 500B-4 successfully separates the free GNP spot from the bound GNP spot, which is similar to the average when the background was not subtracted (cf., low histogram counts in section 3).

2D histogram 500B-5 shows a sharp separation between the free and bound GNPs. The yellow spot that was in zones 2 and 3 has been reduced even more. The region with the red spot (bound GNPs, region 4) is more pinched off into its own cloud of intensity, better separated from the cloud along the left (free GNPs, region 1). The yellow density (free GNPs) is hard to see anywhere. Also noteworthy is a slight shift of the red spot toward slightly lower brightness (region 4); this shift should not be a problem because this spot is better separated from the cloud to the left (frec GNPs).

2D histogram 500B-6 looks similar to 2D histogram 500A-6. The approach still works well to improve the separation between the free and bound GNPs.

Applying a background subtraction filter can improve the differentiation between free and bound particles. This improvement is most noticeable when using the geometric mean (cf. 2D histograms 500A-5 and 500B-5). This result is due to the non-linearity of the geometric mean operation (cf. Eqs. 2). In some embodiments, other algorithms (e.g., non-linear algorithms) could be used to greater improve the separation between the free and bound objects.

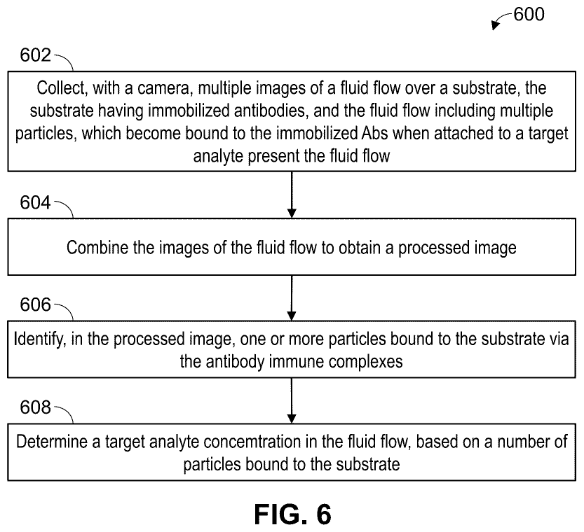

FIG. 6 is a flow chart illustrating steps in a method 600 for capturing images of a liquid immunoassay to determine a target analyte concentration in a fluid sample, according to some embodiments. In some embodiments, at least one or more steps in method 600 may be performed by a computer in a client device, server, or database as disclosed herein (e.g., client device 110, server 130, and database 152). The computer may include a processor executing instructions stored in a memory, and a communications module to exchange data with the server or database through a network, as disclosed herein (cf. processor 112, memory 120, communications module 118, data 120, and network 150). In some embodiments, methods consistent with the present disclosure may include at least one or more steps in method 600 performed in a different order, simultaneously, quasi-simultaneously, or overlapping in time.

Step 602 includes collecting, with a camera, multiple images of a fluid flow over a substrate, the substrate having immobilized antibodies, and the fluid flow including multiple particles, which become bound to the immobilized Abs when attached to a target analyte present in the fluid flow. In some embodiments, step 602 includes collecting at least one image over an exposure time that is commensurate with a time it takes a free particle in the fluid flow to cross a field of view of the camera. In some embodiments, step 602 includes collecting at least two images at two different times and combining the images of the fluid flow comprises averaging each pixel value in the two images. In some embodiments, step 602 includes collecting images at a time interval that is commensurate (albeit smaller) with a time it takes for a free particle in the fluid flow to cross a field of view of the camera. In some embodiments, the time interval for image collection in step 602 may be much smaller than the time it takes for the particles to cross the field of view of the camera and is sufficient to allow the particles to move by a few effective diameters in the fluid flow direction. In some embodiments, step 602 includes determining a background value for each of the images and removing the background value from each of the images prior to combining the images to form the processed image.

Step 604 includes combining the images of the fluid flow to obtain a processed image. In some embodiments, step 604 includes performing a geometric average for each pixel value in the images over the images. In some embodiments, step 604 includes extracting a red image from an image collected at a first time, extracting a green image from an image collected at a second time, extracting a blue image from an image collected at a third time, and to form the processed image comprises combining the red image, the green image, and the blue image, further wherein identifying one or more particles bound to the substrate comprises identifying one or more orange particles in the processed image. In some embodiments, step 604 includes extracting, or collecting two or more color component images at different times, and further wherein selectively identifying one or more particles bound to the substrate comprises identifying one or more particles based on a combination of two or more color components associated with the two or more color component images.

In some embodiments, a color “signature” of a free particle (e.g., the absorption or scattering at the red, green or blue part of the spectrum or any combination thereof) may be selected to discriminate from the color signature of a fixed particle. In the examples discussed above (cf. FIGS. 3B and 4A), metrics such as a direct absorption/scattering, also known as “the spectrum” may be selected for this signature. In some embodiments, methods consistent with the present disclosure may include step 604 wherein other metrics that could be used to discriminate free particles from bound particles (e.g., ratio of signals, differences between signals, or any other linear or non-linear function of a combination or signature of red, green, blue pixel values). For example, in some embodiments step 604 may include absorption at two different spectral areas formed by a subtraction (R−G) and an addition (R+B) of different colors, or may include a ratio, e.g., (R−G)/B and (R+B)/G, and the like.

Step 606 includes identifying, in the processed image, one or more particles bound to the surface via antibody immune complexes. In some embodiments, step 606 includes applying a brightness mask to the processed image to filter out pixel values lower than a predetermined threshold.

Step 608 includes determining a target analyte concentration in the fluid flow based on a number of particles bound to the substrate. In some embodiments, step 608 includes assigning a negative result for the assay when the number of particles bound to the substrate is less than a pre-selected threshold after a pre-determined time has lapsed from an assay start. In some embodiments, step 608 includes washing the assay to remove free particles from the substrate when the number of particles bound to the substrate is higher than a pre-selected threshold.

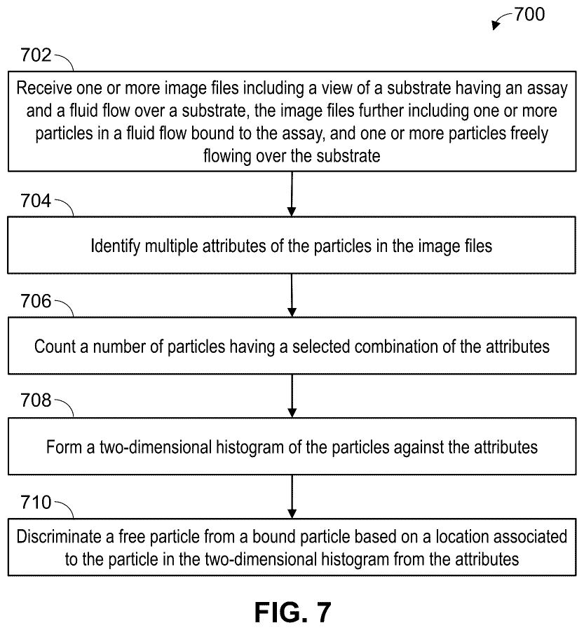

FIG. 7 is a flow chart illustrating steps in a method for analyzing images from a liquid immunoassay, according to some embodiments. In some embodiments, at least one or more steps in method 700 may be performed by a computer in a client device, server, or database as disclosed herein (e.g., client device 110, server 130, and database 152). The computer may include a processor executing instructions stored in a memory, and a communications module to exchange data with the server or database through a network, as disclosed herein (cf. processor 112, memory 120, communications module 118, data 120, and network 150). In some embodiments, methods consistent with the present disclosure may include at least one or more steps in method 700 performed in a different order, simultaneously, quasi-simultaneously, or overlapping in time.

Step 702 includes receiving an image file including a view of a substrate having an assay and a fluid flow over the substrate, the image file further including one or more particles in the fluid flow bound to the assay, and one or more particles freely flowing over the substrate. In some embodiments, step 702 includes receiving multiple raw images of the fluid flow, determining a background level in each raw image, and filtering the background level from the raw images to form a processed image.

Step 704 includes identifying multiple attributes of the particles in the image file. In some embodiments, step 704 includes selecting a particle brightness and a particle color. In some embodiments, step 704 includes selecting the attributes based on a false positive count for bound particles and free particles, resulting from the two-dimensional histogram. In some embodiments, step 704 includes selecting at least one of the attributes from a non-linear combination of one or more attributes of the particles in the image file.

Step 706 includes counting a number of particles having a selected combination of the attributes.

Step 708 includes forming a two-dimensional histogram of the particles against the attributes.

Step 710 includes discriminating a free particle from a bound particle based on a location associated to the particle in the two-dimensional histogram from the attributes. In some embodiments, the particles are configured to capture a target analyte present in the fluid flow and to become bound to the functionalized surface thereafter, and step 710 further includes identifying a sensitivity and a specificity of the assay relative to the target analyte based on the two-dimensional histogram. In some embodiments, step 710 further includes identifying a first region of the two-dimensional histogram associated with a free particle and a second region of the two-dimensional histogram associated with a bound particle. In some embodiments, step 710 further includes associating a likelihood that a particle is not a bound particle based on a location associated to the particle in the two-dimensional histogram from the attributes. In some embodiments, step 710 further includes identifying a first centroid of a first region in the two-dimensional histogram associated with bound particles, identifying a second centroid of a second region in the two-dimensional histogram associated with free particles, and projecting the two-dimensional histogram on a plane containing a line joining the first centroid and the second centroid to obtain a distribution indicative of a likelihood that a particle is free or bounded based on the attributes. In some embodiments, the attributes include three attributes of the particles in the image file, and step 710 further includes forming a three-dimensional histogram of the particles against the attributes.

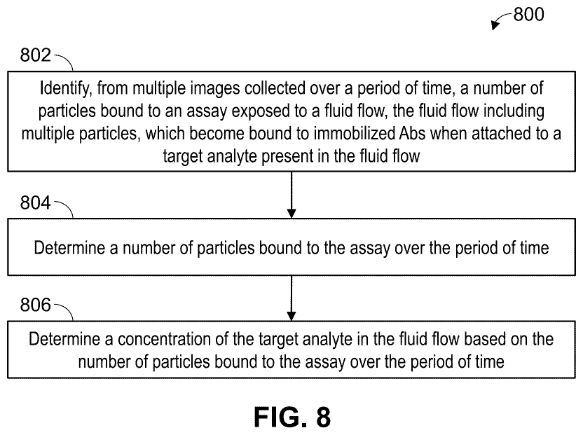

FIG. 8 is a flowchart illustrating steps in a method for determining a target analyte concentration in a fluid sample, according to some embodiments. In some embodiments, at least one or more steps in method 800 may be performed by a computer in a client device, server, or database as disclosed herein (e.g., client device 110, server 130, and database 152). The computer may include a processor executing instructions stored in a memory, and a communications module to exchange data with the server or database through a network, as disclosed herein (cf. processor 112, memory 120, communications module 118, data 120, and network 150). In some embodiments, methods consistent with the present disclosure may include at least one or more steps in method 800 performed in a different order, simultaneously, quasi-simultaneously, or overlapping in time.

Step 802 includes identifying, from multiple images collected over a period of time, a number of particles bound to an assay exposed to a fluid flow, the fluid flow including multiple particles, which become bound to the immobilized Abs when attached to a target analyte present in the fluid flow. In some embodiments, step 802 includes averaging the images to form a processed image and applying a threshold mask to remove free particles from the processed image. In some embodiments, step 802 includes forming a processed image with a geometric average of the images and applying a threshold mask to remove free particles from the processed image. In some embodiments, step 802 includes filtering the images with at least one or more colors and combining the images to form a processed image and applying a color mask to remove free particles from the processed image. In some embodiments, step 802 includes forming a two-dimensional histogram for particles in the images and identifying the particles bound to the assay based on a location of a point formed with two particle attributes, for each particle, in the two-dimensional histogram. In some embodiments, step 802 includes: selecting multiple image attributes for a particle in the images; forming a multi-dimensional histogram for particles in the images, and identifying the particles bound to the assay based on a location of a point formed with two particle attributes, for each particle, in the multi-dimensional histogram.

Step 804 includes determining a number of particles bound to the assay over the period of time.

Step 806 includes determining a concentration of the target analyte in the fluid flow based on the number of particles bound to the assay over the period of time. In some embodiments, the fluid flow includes a biological sample from a subject and the target analyte is a pathogen, and step 806 further includes assessing a disease condition for the subject based on the concentration of the target analyte. In some embodiments, step 806 further includes stopping the fluid flow when the concentration of the target analyte in the fluid flow is less than a pre-determined threshold. In some embodiments, step 806 further includes causing a fluid flow system to wash the assay when a number of free particles in the images is larger than a pre-selected value. In some embodiments, step 806 further includes adjusting a fluid flow rate based on a precision value for the concentration of the target analyte.

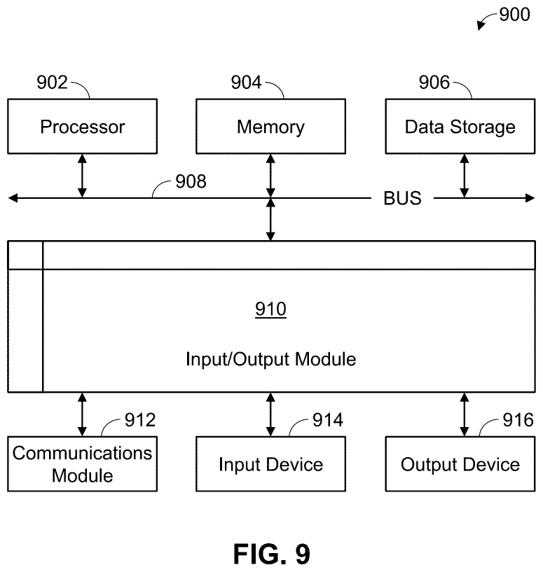

FIG. 9 is a block diagram illustrating an exemplary computer system 900 with which headsets and other client devices 110, and methods 600-800 can be implemented. In certain aspects, computer system 900 may be implemented using hardware or a combination of software and hardware, either in a dedicated server, or integrated into another entity, or distributed across multiple entities. Computer system 900 may include a desktop computer, a laptop computer, a tablet, a phablet, a smartphone, a feature phone, a server computer, or otherwise. A server computer may be located remotely in a data center or be stored locally.

Computer system 900 includes a bus 908 or other communication mechanism for communicating information, and a processor 902 (e.g., processor 112) coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904 (e.g., memory 120), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, e.g., one or more modules of computer program instructions encoded on a computer-readable medium for execution by, or to control the operation of, the computer system 900, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled with bus 908 for storing information and instructions. Computer system 900 may be coupled via input/output module 910 to various devices. Input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, input/output module 910 is configured to connect to a plurality of devices, such as an input device 914 and/or an output device 916. Exemplary input devices 914 include a keyboard and a pointing device, e.g., a mouse or a trackball, by which a consumer can provide input to the computer system 900. Other kinds of input devices 914 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 916 include display devices, such as an LCD (liquid crystal display) monitor, for displaying information to the consumer.

According to one aspect of the present disclosure, headsets and client devices 110 can be implemented, at least partially, using a computer system 900 in response to processor 902 executing one or more sequences of one or more instructions contained in memory 904. Such instructions may be read into memory 904 from another machine-readable medium, such as data storage device 906. Execution of the sequences of instructions contained in main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a free telephone, a PDA, a free audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires forming bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a claim may be amended to include some or all of the words (e.g., instructions, operations, functions, or components) recited in either one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

When taking three independent images, some adjustments may optionally be made to ensure the particles are imaged properly in the RGB version of the image. There are two issues that can occur that if not corrected for, which may compromise the image quality: (i) small differences in the magnification (and therefore field of view) that depend on the wavelength of light that is used; these differences are systematic and depend on the details of the optics used for the imaging; and (ii) small shifts in the physical location of the region being imaged. Shifts of a few microns are enough to shift where an object appears in an image.

To automate the process of adjusting the three individual images and stacking them together to create the RGB image, an algorithm (e.g., a computer script) can be employed, which performs the following tasks. (1) Resizing each of the three original images as needed to correct for the wavelength dependent differences in the magnification factor. (2) Cropping or padding each resized image to create an image that has the same number of pixels as the original image. The net result is to have an image that maintains the original size in the context of width and height in pixels but has been rescaled to represent the same physical field of view. (3) Determining any translational offsets needed for aligning the rescaled images with each other.

One of the three images is considered as the reference and needs no offsets. Each of the other two images is evaluated to determine if it should be shifted slightly along the width or height to improve the alignment of the images. Rotational adjustments are not needed, however they may be performed if needed. The amount of translational offset to optimize the alignment is determined using a template matching algorithm from a library of computer vision functions. The idea is to provide the algorithm with a small region from the reference image and a small region from the image being evaluated and the algorithm will determine how many pixels the image should be translated in each direction to maximize the alignment of these small regions.

To improve the robustness of the offset determination, the determination process may be performed a plurality of times (e.g., two, three, four, five, six, seven, eight, nine, ten, or more times) using a plurality of different paired regions corresponding to the plurality of times (e.g., two, three, four, five, six, seven, eight, nine, ten, or more different paired regions) to get a plurality of independent assessments of the optimal offset in each direction.

The robustness of the solution can be assessed by looking at the distribution of the plurality of offset values for each direction, and the median values are used as the optimal values of the offsets for the full image.

A search range of the offset values may be limited by controlling the sizes of the small regions used for the evaluations.

To apply the offset, an image may be cropped using the optimal offsets and then the perimeter may be padded to restore the original image size.

The RGB image is constructed by stacking together the reference image with the two modified images that have been aligned with the reference image using this process.

The following Examples provide describe additional, non-limiting aspects of the present invention.

### Example 1

An RGB image was constructed by stacking together three separate individual images taken with a monochrome camera and red, green, and blue LEDs. Scattering by the particles was more pronounced with red light than with green or blue light. Based on the imaging conditions and RGB visualization process, mobile particles appeared as red, green or blue objects, whereas stationary particles appeared reddish-brown due to the combination of the red, green and blue intensities.

Individual pixel intensities were filtered based on the following logic. If the red intensity was greater than both the green intensity and the blue intensity then pixel intensity was maintained. Otherwise, the pixel was set to black. This process removed pixels corresponding to mobile particles seen in the green and blue channels but will not remove mobile particles that were seen in the red channel. Therefore, objects corresponding to stationary particles (appear reddish-brown) and mobile particles in the red channel (appear pure red) would be expected. Comparing the images before and after this color-based pixel filtering, it can be seen that the green and blue objects were removed and only the reddish-brown and pure red objects remained.

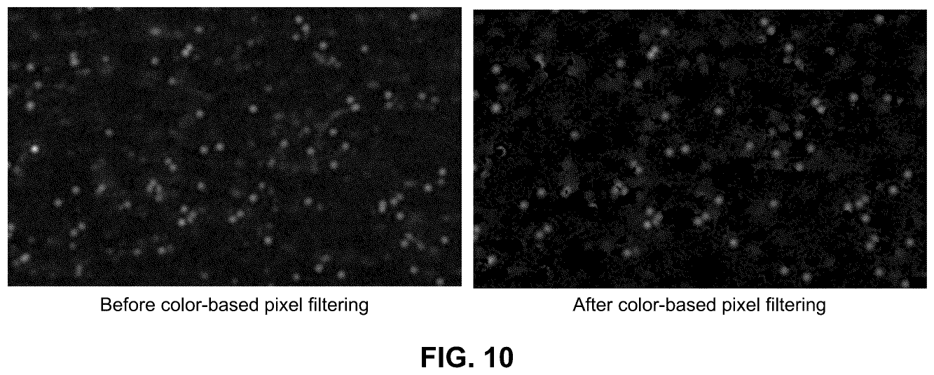

These results shown in FIG. 10 demonstrate the ability of the color-based filtering to remove the undesirable objects from the image. Additional filtering could be used to differentiate between stationary objects and mobile objects appearing in the individual red channel.

### Example 2

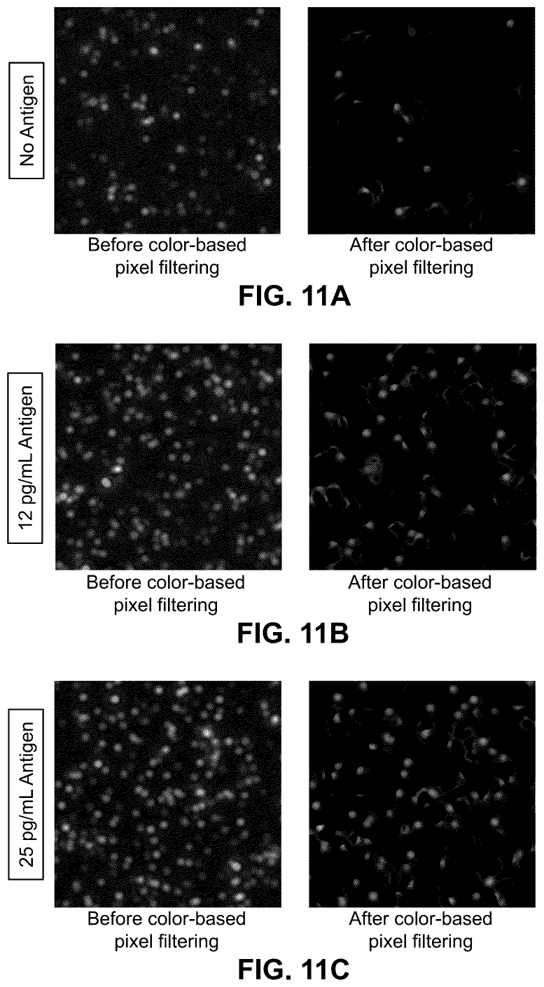

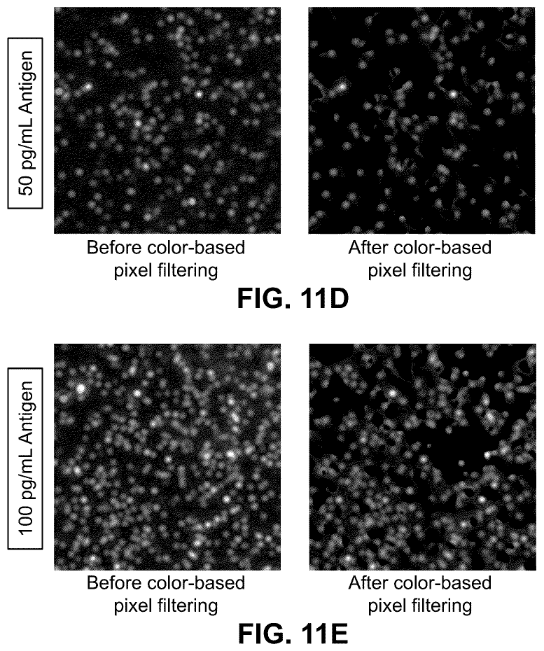

A series of titration experiments was performed using different concentrations of antigen: 0 pg/mL, 12 pg/mL, 25 pg/mL, 50 pg/mL, and 100 pg/mL antigen. A pair of images—one image before color-based pixel filtering and one image after filtering—was prepared for each concentration of antigen. For each antigen concentration a small portion of the image is shown before and after pixels have been filtered based on their color signature. See FIGS. 11A-11E.

The RGB images were constructed by stacking together three separate individual images taken with a monochrome camera and different LED colors. Since the individual images were taken at slightly different times, mobile particles can appear in different locations in each of the individual color channel images. Therefore, these mobile particles visualize as red, green, or blue objects. In contrast, stationary particles visualize as the combination of their red, green, and blue intensities. For the imaging conditions used for this series of titrations, this combination of colors resulted in a yellowish-gold object.

As shown in FIGS. 11A-11E, color-based filtering was performed on the individual pixels of the image such that the pixels with a color signature consistent with a stationary particle were maintained and pixels with a color signature consistent with mobile particles were set to black. This filtering removed the mobile particles from the image, leaving only the stationary particles.

From the series of images corresponding to the antigen titration, it can be seen that the number of mobile particles (i.e., red, green or blue objects) is approximately the same for each antigen concentration, whereas the number of stationary particles increases with antigen concentration. These trends are consistent with a titration experiment where the number of captured particles scale with antigen concentration and the wash has not fully cleared away all unbound particles.

### Example 3

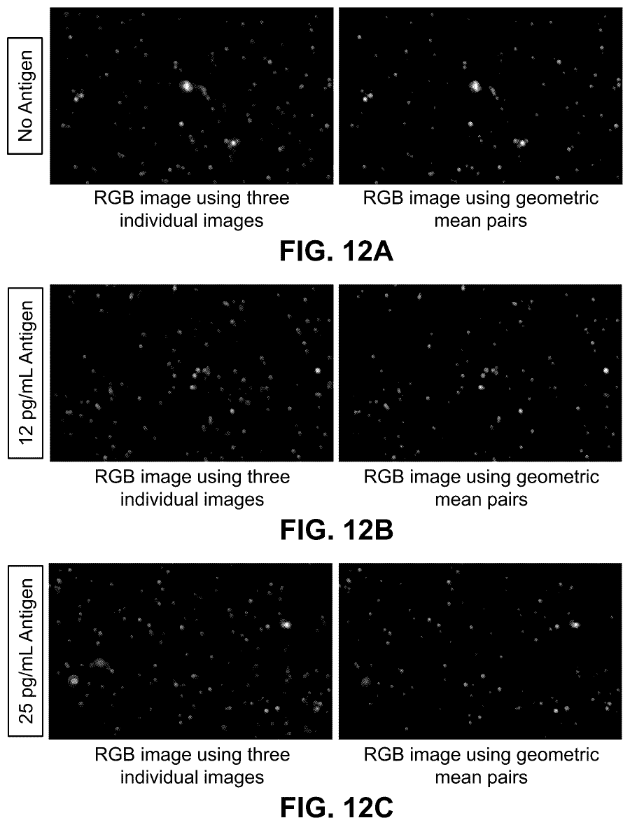

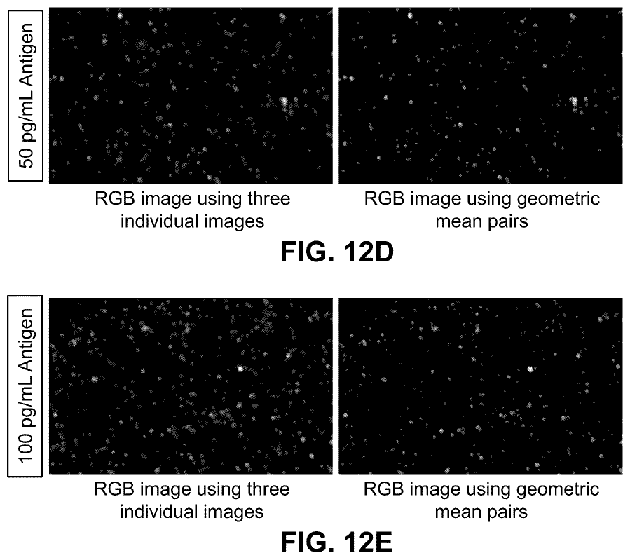

A series of titration experiments was performed using different concentrations of antigen: 0 pg/mL, 12 pg/mL, 25 pg/mL, 50 pg/mL, and 100 pg/mL antigen. For each antigen concentration a small portion of the image is shown for two types of RGB images that were constructed using different individual images taken with a monochrome camera and different color LEDs. Four individual images were taken: one using a red LED, two using a green LED, and one using a blue LED. See FIGS. 12A-12E.

The first RGB image was constructed using one image from each LED color. The second RGB image was made in a two-step process. Step 1: create three “Geomean” images by calculating the geometric mean for each pixel using two images. Geomean_Red: used the red image and the first green image; Geomen_Green: used the two green images; and Geomean_Blue: used the blue image and the first green image. Step2: create the RGB image using these three Geomean images: The geometric mean calculation tended to maintain the pixel intensities corresponding to a stationary particle and tended to diminish the pixel intensities of mobile particles. Since the particles scattered red light more strongly than green or blue light, the stationary particles appear as reddish and the mobile particles appear as green, blue or more pure red. Using the geomean images for the RGB image removed many of the non-red objects and diminished the intensity of some of the more pure red objects while maintaining other reddish objects.

From the series of images corresponding to the antigen titration, it can be seen that the number of particles increases with increasing antigen concentration. Using the non-red particles to estimate the number of mobile particles, similar numbers of particles are seen regardless of the antigen concentration. These trends are consistent with a titration experiment where the number of captured particles scale with antigen concentration and the wash has not fully cleared away all unbound particles.

### Example 4

The locations of objects seen in a series of eight sequential images were plotted. An experiment was run using 50 pg/mL antigen and a series of sequential images were taken over the course of a few seconds. The images were analyzed with a particle-finding algorithm and each particle was classified based on it total brightness and it redness (i.e., fraction of the total brightness due to red intensity).

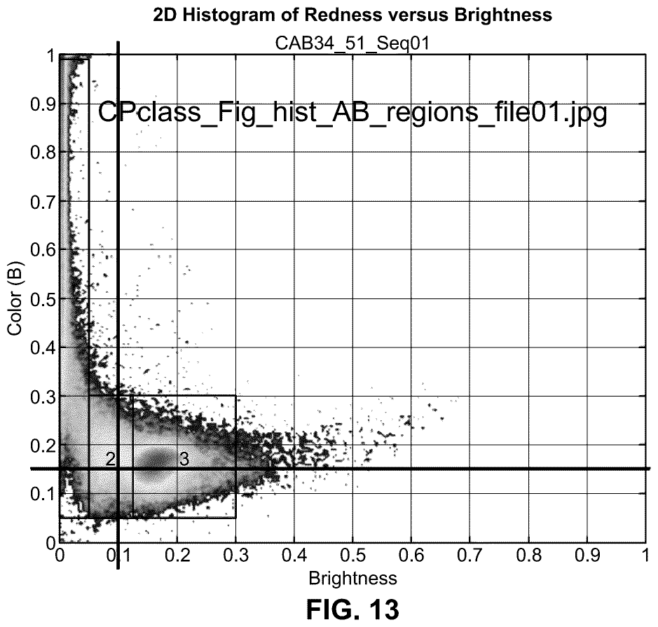

The 2D histogram in FIG. 13 shows the distribution of these metrics for all the particles found in the image. There are two main peaks of interest:
Main peak with brightness centered near 0.17 and redness of about 0.17
Minor peak with brightness centered near 0.08 and redness of about 0.18

To understand how the locations of particles found by the algorithm might change over time, pixel locations of the objects for the same small region of each of the eight serial images were plotted. Based on the brightness ranges of the main and secondary peaks, two plots were made: (1) The plot for the main peak only used objects with a brightness between 0.12 and 0.22; and (2) The plot for the secondary peak only used objects with a brightness of 0.04 to 0.12.

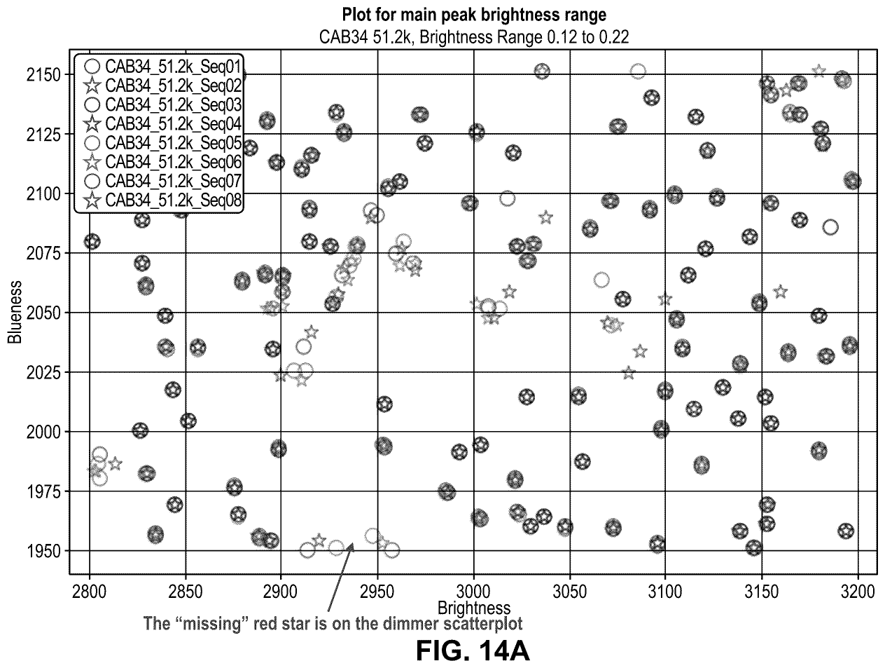

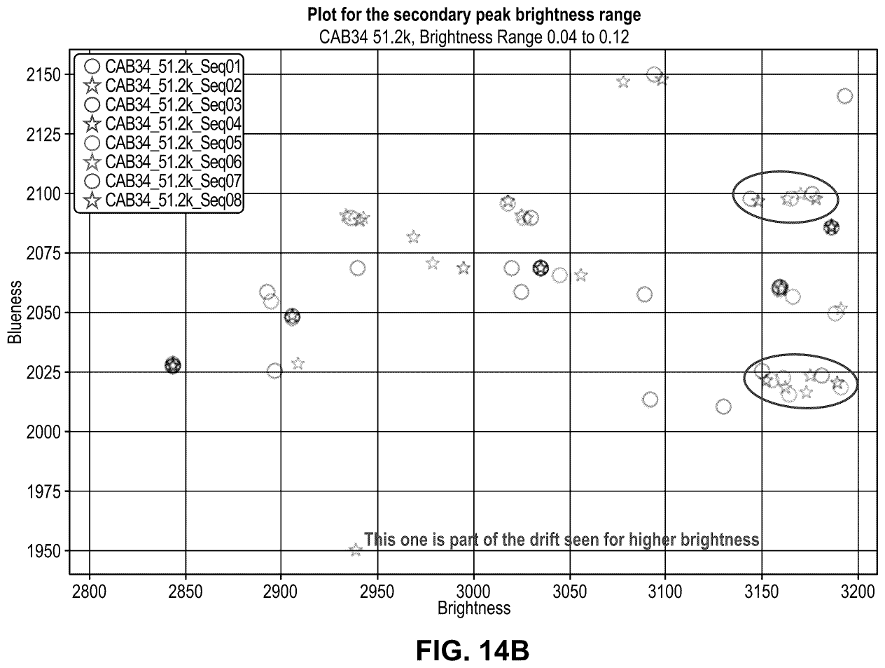

For the main peak (see FIG. 14A), it can be seen that most objects maintained their location for the series of eight sequential images (i.e., scatterplot points are overlapping at the same position). It can be seen that small number of cases where the points are slightly shifted from each other, indicating the object moved while the images were captured.

For the secondary peak (see FIG. 14B), it can be seen that there are fewer objects in general and very few maintained their locations for the series of eight images. In a couple cases (circled on the plot), it can be seen that there was a systematic drift to the right. But most cases are spurious such that only a few instances were observed wherein an object was indicated as having moved away, or changed brightness enough to not be included. It should be noted that vertical movement vertically will result in the particle moving out of the well-focused region based on the depth of field, which could explain why they are not seen in other images.

Tracking the object location over a series of sequential images confirmed that the stationary and mobile objects can be differentiated based on how they visualize in the images and are characterized by the algorithm the finds and classifies the objects.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “include” as “include” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A method, comprising:
collecting, with a camera, multiple images of a fluid flow over an assay, the assay including a substrate having a surface that is functionalized with Abs, and the fluid flow including multiple particles, which become bound to functionalized surface when a target analyte is present;
combining the images of the fluid flow to obtain a processed image;
identifying, in the processed image, one or more particles bound to the substrate; and
determining a target analyte concentration in the fluid flow based on a number of particles bound to the substrate.

2. The method of claim 1, wherein collecting multiple images of the fluid flow comprises collecting at least one image over an exposure time that is shorter than a time it takes a free particle in the fluid flow to cross a field of view of the camera.

3. The method of claim 1, wherein collecting multiple images of the fluid flow comprises collecting at least two images at two different times, and combining the images of the fluid flow comprises averaging each pixel value in the two images.

4. The method of claim 1, wherein collecting multiple images of the fluid flow comprises collecting images at a time interval that is commensurate with a time it takes for a free particle in the fluid flow to cross a distance equivalent to multiple effective diameters of the particles.

5. The method of claim 1, wherein collecting multiple images of the fluid flow comprises determining a background value for each of the images, and removing the background value from each of the images prior to combining the images to form the processed image.

6. The method of claim 1, wherein combining the images of the fluid flow comprises performing a geometric average for each pixel value in the images over the images.

7. The method of claim 1, wherein combining the images of the fluid flow comprises extracting, or collecting a red image from an image collected at a first time, extracting or collecting a green image from an image collected at a second time, extracting or collecting a blue image from an image collected at a third time, and to form the processed image comprises combining the red image, the green image, and the blue image, further wherein selectively identifying one or more particles bound to the substrate comprises identifying one or more particles based on a combination of a red, a green and a blue image per particle, in the processed image.

8. The method of claim 1, wherein combining the images of the fluid flow comprises extracting, or collecting two or more color component images at different times, and further wherein selectively identifying one or more particles bound to the substrate comprises identifying one or more particles based on a combination of two or more color components associated with the two or more color component images.

9. The method of claim 1, wherein identifying one or more particles bound to the substrate comprises applying a brightness mask to the processed image to filter out pixel values lower than a predetermined threshold.

10. The method of claim 1, wherein determining a target analyte concentration in the fluid flow comprises assigning a negative result for the assay when the number of particles bound to the substrate is less than a pre-selected threshold after a pre-determined time has lapsed from an assay start.

11. The method of claim 1, further comprising washing the surface to remove free particles from the substrate when the number of particles bound to the substrate is higher than a pre-selected threshold.

12. A computer-implemented method, comprising:
receiving an image file including a view of a substrate having immobilized Abs against a target analyte and a fluid flow over the substrate, the image file further including one or more particles in the fluid flow bound to an assay through immune complexes, and one or more particles freely flowing over the substrate;
identifying multiple attributes of the particles in the image file;
counting a number of particles having a selected combination of the attributes;
forming a two-dimensional histogram of the particles against the attributes; and
discriminating a free particle from a bound particle based on a location associated to the particle in the two-dimensional histogram from the attributes.

13. The computer-implemented method of claim 12, wherein receiving an image file comprises receiving multiple raw images of the fluid flow, determining a background level in each raw image, and filtering the background level from the raw images to form a processed image.

14. The computer-implemented method of claim 12, wherein identifying at least two attributes of the particles in the image file comprises selecting a particle brightness and a particle color.

15. The computer-implemented method of claim 12, wherein identifying at least two attributes of the particles in the image file comprises selecting the attributes based on a false positive count for bound particles and free particles, resulting from the two-dimensional histogram.

16. The computer-implemented method of claim 12, wherein identifying at least two attributes of the particles in the image file comprises selecting at least one of the attributes from a non-linear combination of one or more attributes of the particles in the image file.

17. The computer-implemented method of claim 12, wherein the particles are configured to capture a target analyte present in the fluid flow and to become bound to the assay thereafter, further comprising identifying a sensitivity and a specificity of the assay relative to the target analyte based on the two-dimensional histogram.

18. The computer-implemented method of claim 12, further comprising identifying a first region of the two-dimensional histogram associated with a free particle and a second region of the two-dimensional histogram associated with a bound particle.

19. The computer-implemented method of claim 12, further comprising associating a likelihood that a particle is not a bound particle based on a location associated to the particle in the two-dimensional histogram from the attributes.

20. The computer-implemented method of claim 12, further comprising:
identifying a first centroid of a first region in the two-dimensional histogram associated with bound particles;
identifying a second centroid of a second region in the two-dimensional histogram associated with free particles; and
projecting the two-dimensional histogram on a plane containing a line joining the first centroid and the second centroid to obtain a distribution indicative of a likelihood that a particle is free or bounded based on the attributes.

21. The computer-implemented method of claim 12, wherein the attributes include three attributes of the particles in the image file, further comprising forming a three-dimensional histogram of the particles against the attributes.

22. A system, comprising:
a memory storing multiple instructions; and
one or more processors configured to execute the instructions and cause the system to perform a process, comprising to:
receive an image file including a view of a substrate having an assay and a fluid flow over the substrate, the image file further including one or more particles in the fluid flow bound to the assay, and one or more particles freely flowing over the substrate;
identify multiple attributes of the particles in the image file;
count a number of particles having a selected combination of the attributes;
form a two-dimensional histogram of the particles against the attributes; and
discriminate a free particle from a bound particle based on a location associated to the particle in the two-dimensional histogram from the attributes.

23. The system of claim 22, wherein to receive an image file the one or more processors execute instructions to receive multiple raw images of the fluid flow, determining a background level in each raw image, and filtering the background level from the raw images to form a processed image.

24. The system of claim 22, wherein to identify at least two attributes of the particles in the image file the one or more processors execute instructions to select a particle brightness and a particle color.

25. The system of claim 22, wherein to identify at least two attributes of the particles in the image file the one or more processors execute instructions to select the attributes based on a false positive count for bound particles and free particles, resulting from the two-dimensional histogram.

26. The system of claim 22, wherein to identify at least two attributes of the particles in the image file the one or more processors execute instructions to select at least one of the attributes from a non-linear combination of one or more attributes of the particles in the image file.

27. The system of claim 22, wherein the particles are configured to capture a target analyte present in the fluid flow and bind through an immune complex bound to a surface functionalized with Abs, wherein the one or more processors further execute instructions to identify a sensitivity and a specificity of the assay relative to the target analyte based on the two-dimensional histogram.

28. The system of claim 22, wherein the one or more processors further execute instructions to identify a first region of the two-dimensional histogram associated with a free particle and a second region of the two-dimensional histogram associated with a bound particle.

29. The system of claim 22, wherein the one or more processors further execute instructions to associate a likelihood that a particle is not a bound particle based on a location associated to the particle in the two-dimensional histogram from the attributes.

30. The system of claim 22, wherein the one or more processors further execute instruction to:
identify a first centroid of a first region in the two-dimensional histogram associated with bound particles;
identify a second centroid of a second region in the two-dimensional histogram associated with free particles; and
project the two-dimensional histogram on a plane containing a line joining the first centroid and the second centroid to obtain a distribution indicative of a likelihood that a particle is free or bounded based on the attributes.

31. The system of claim 22, wherein the attributes include three attributes of the particles in the image file, and the one or more processors further execute instructions to form a three-dimensional histogram of the particles against the attributes.
